(19) United States
(12) Patent Application Publication
(10) Pub. No.: US 2025/0224025 A1
(43) Pub. Date: Jul. 10, 2025

(54) SYSTEMS AND METHODS FOR DYNAMIC AND CONTINUOUS PHASE ADJUSTMENT USING STRAIN-WAVE GEARING FOR POWER TRANSMISSION SHAFTS

(71) Applicant: Tesla, Inc., Austin, TX (US)

(72) Inventors: Marko Niksz, San Francisco, CA (US); Nicolas Malecek, San Francisco, CA (US); Christopher Enuke, Los Altos, CA (US)

(73) Assignee: Tesla, Inc., Austin, TX (US)

(21) Appl. No.: 18/408,799

(22) Filed: Jan. 10, 2024

(51) Int. Cl. F16H 49/00

(52) U.S. Cl. CPC F16H 49/001; F16H 2049/003

(57) ABSTRACT

Systems and methods that are configured to provide dynamic and continuous phase adjustment using strain-wave gearing for power transmission shafts.

### BACKGROUND OF THE DISCLOSURE

Power transmission assemblies have many uses where rotary torque adjustment is necessary. One of the uses is for gear testing and development. Existing systems to adjust phase and torque are bulky, limited in torque output, and require dangerous manual torque loading. In order to adjust the torque of the power transmission assembly, the assembly needs to be stopped and then the torque may be adjusted. All of these issues are undesirable.

### SUMMARY OF THE DISCLOSURE

According to one aspect of the present disclosure, systems and methods are provided that are configured to provide dynamic and continuous phase adjustment using strain-wave gearing for power transmission shafts (e.g., in test equipment devices).

In some embodiments, a power transmission assembly may include a first shaft along an axis, the first shaft having a first end and a second end, a second shaft along the same axis as the first shaft, the second shaft having a first end and a second end. The first end of the second shaft is configured to engage with the second end of the first shaft. A first input gear may be coupled to a portion of the first shaft. A harmonic drive shaft may be engaged coaxially within the first shaft with a harmonic drive engaged with the harmonic drive shaft adjacent the second end of the first shaft. The harmonic drive may be further engaged with the first end of the second shaft, and a second input gear may be coupled to a portion of the second shaft. The harmonic drive may include an elliptical wave generator coupled to the harmonic drive shaft, a flexspline engaged with the elliptical wave generator, and a circular spline surrounding at least a portion of the flexspline, the circular spline engaged with the flexspline, and configured to engage with the first end of the second shaft.

In some embodiments, an illustrative application/method of the power transmission assembly is provided. The illustrative method may include providing a power transmission assembly, which may include a first shaft along an axis, the first shaft having a first end and a second end, a second shaft along the same axis as the first shaft, the second shaft having a first end and a second end. The first end of the second shaft is configured to engage with the second end of the first shaft. A first input gear may be coupled to a portion of the first shaft. A harmonic drive shaft may be engaged coaxially within the first shaft, with a harmonic drive engaged with the harmonic drive shaft adjacent the second end of the first shaft. The harmonic drive may be further engaged with the first end of the second shaft, and a second input gear may be coupled to a portion of the second shaft The illustrative method may further include applying a first torque to the harmonic drive shaft, the first torque causing a second torque exerted on the first shaft, such that the second torque direction is opposite the first torque direction, and wherein the second torque causes the first input gear to rotate in the same direction as the first shaft. The illustrative method may further include the second torque causing a third torque applied to the second shaft, the third torque applied in a direction opposite the second torque, the third torque causing the second input gear to rotate in the same direction as the second shaft.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1 is an example power transmission assembly according to some embodiments of the present disclosure.

FIG. 2A is a view of an example power transmission assembly coupled to a motor according to some embodiments of the present disclosure.

FIG. 2B is a side view of an example power transmission assembly coupled to a motor according to some embodiments of the present disclosure.

FIG. 3 illustrates an example of a harmonic drive that may be used in the assembly of FIG. 1.

FIG. 4 is an example power transmission assembly showing torque direction according to some embodiments of the present disclosure.

FIG. 5A is an example application of a power transmission assembly according to some embodiments of the present disclosure.

FIG. 5B is a view of a power transmission assembly in an example application according to some embodiments of the present disclosure.

The drawings are not necessarily to scale, or inclusive of all elements of a system, emphasis instead generally being placed upon illustrating the concepts, structures, and techniques sought to be protected herein.

### DESCRIPTION

The following detailed description is merely exemplary in nature and is not intended to limit the claimed invention or the applications of its use.

Embodiments of the present disclosure are directed to systems and methods for providing dynamic and continuous phase adjustment using strain-wave gearing for power transmission shafts. The disclosed power transmission assembly may utilize a coaxial harmonic drive shaft coupled with a harmonic drive to increase the torque of the input gears based on the rotation of the harmonic drive shaft. Due to the nature of the harmonic drive, the harmonic drive shaft may be turned infinitely without having to revert to an initial position. As the harmonic drive shaft is rotated, a torque in the opposite direction may be exerted on a first shaft of the power transmission assembly. This torque may be transferred to a first input gear coupled to the first shaft. The first input gear may be engaged with an outside instrument that needs to be rotated. As the harmonic drive shaft is rotated, a torque in the same direction as the rotation of the harmonic drive shaft may be exerted on a second shaft of the power transmission assembly due to the configuration of the engagement between the first shaft and the second shaft. The torque exerted on the second shaft may be transferred to a second input gear coupled to the second shaft. The second input gear may be engaged with a second outside instrument that needs to be rotated.

In some embodiments, the first shaft, the second shaft, and the harmonic drive shaft are all along the same axis with the harmonic drive shaft disposed within the first shaft. In some embodiments, the harmonic drive comprises an elliptical wave generator coupled to the harmonic drive shaft, a flexspline engaged with the elliptical wave generator, and a circular spline surrounding at least a portion of the flexspline, the circular spline engaged with the flexspline, and configured to engage with the first end of the second shaft. In some embodiments, the engagement between the first shaft and the second shaft may comprise the harmonic drive.

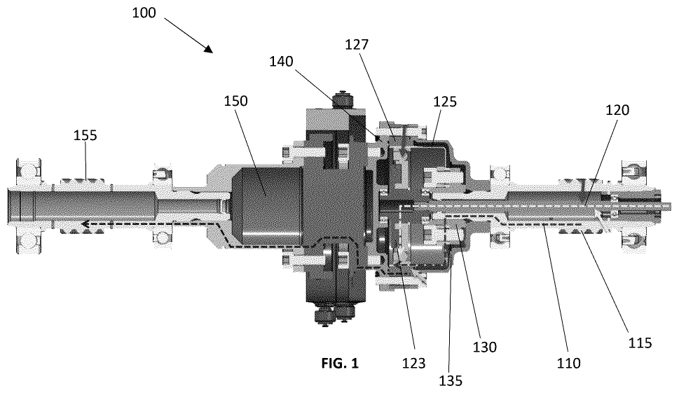

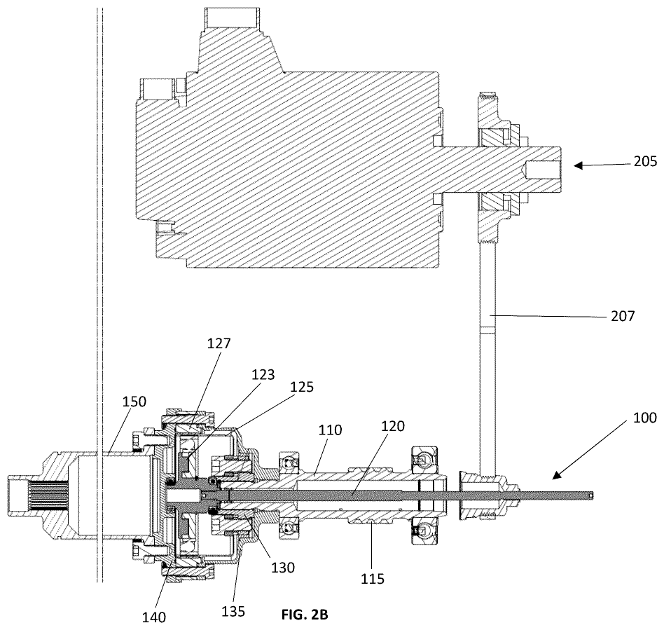

Referring now to FIG. 1, an illustrative power transmission assembly 100 is shown according to some embodiments of the present disclosure. In some embodiments, the power transmission assembly 100 may include a first shaft 110 along an axis and a second shaft 150 along the same axis. The first shaft 110 may include a first input gear 115 coupled coaxially to the first shaft 110 such that they are configured to rotate together. In some embodiments, there may be a harmonic drive shaft 120 disposed coaxially within the first shaft 110. The harmonic drive shaft 120 may rotate independently from the first shaft 110. The harmonic drive shaft 120 may be coupled to an elliptical wave generator 123 such that the elliptical wave generator 123 is configured to rotate together with the harmonic drive shaft 120. The elliptical wave generator 123 may be engaged with a flexspline 125, which may be at least partially surrounded by and engaged with a circular spline 127. As shown in FIG. 3, the flexspline 125 may have gear teeth disposed on its outer circumference, and the circular spline 127 may have gear teeth disposed on its inner circumference. The number of the gear teeth on the flexspline 125 may be less than the number of the gear teeth on the circular spline 127. A person of skill in the art will understand that when the elliptical wave generator 123, the flexspline 125, and the circular spline 127 are engaged in this configuration, the flexspline 125 will rotate in a direction opposite the direction of the elliptical wave generator 123 and with a greater torque than that of the elliptical wave generator 123.

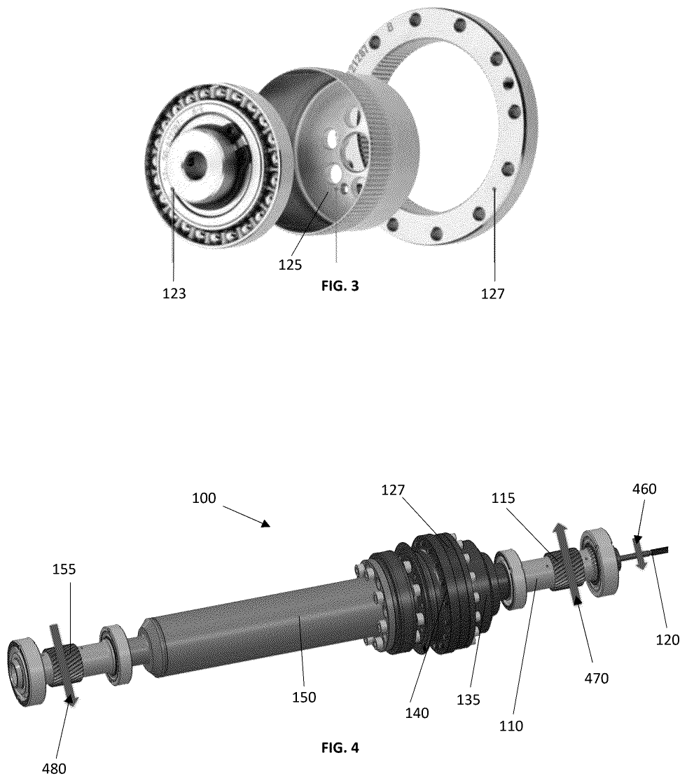

Referring again to FIG. 1, in some embodiments, the flexspline 125 may be coupled to a flexspline adapter 130. The flexspline adapter 130 may be coupled to the first shaft 110 such that the first shaft 110 may rotate together with the flexspline 125 in the same direction and with the same torque. Due to the engagement of the flexspline 125 and the circular spline 127, the rotation of the flexspline 125 may cause a transfer of torque to the circular spline 127. However, the torque of the circular spline 127 may be in a direction opposite the torque of the flexspline 125 and in the same direction as the torque of the harmonic drive shaft 120. The torque of the harmonic drive shaft 120 may be referred to as a first torque 460 shown in one embodiment in FIG. 4. The torque of the flexspline 125 may be referred to as a second torque 470 shown in one embodiment in FIG. 4. The torque of the circular spline 127 may be referred to as a third torque 480 shown in one embodiment in FIG. 4.

Referring again to FIG. 1, in some embodiments, the circular spline 127 may be coupled to a circular spline adapter 140. The circular spline adapter 140 may be coupled to the second shaft 150 such that the second shaft 150 may rotate together with the circular spline 127 in the same direction and with the same torque. The second shaft 150 may include a second input gear 155 coupled coaxially to the second shaft 150 such that they are configured to rotate together.

Thus, in some example embodiments, when the harmonic drive shaft 120 is rotated clockwise with a first torque, the first shaft 110 may rotate counter-clockwise with a second torque, and the second shaft 150 may rotate clockwise with a third torque.

In some embodiments, the power transmission assembly 100 may include a shaft support 135. The shaft support 135 may be configured to mount the harmonic drive assembly concentrically with the first shaft 110 and the second shaft 150. In some embodiments, the shaft support 135 may be coupled to the circular spline 127 such that the shaft support 135 may rotate with the second shaft 150. The shaft support 135 may be disposed around a portion of the first shaft 110, but the shaft support 135 may be configured to rotate independently from the first shaft 110.

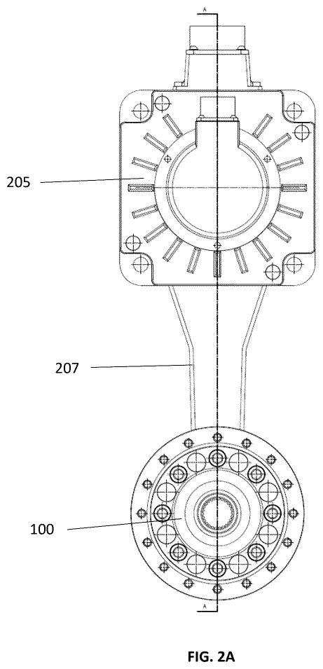

Referring now to FIG. 2A, an example power transmission assembly 100 is shown coupled to a motor 205 according to some embodiments of the present disclosure. This view is along the axis of the power transmission assembly 100. In some embodiments, the power transmission assembly 100 and the motor 205 may be coupled by a drive belt 207. In some embodiments, the motor 205 may be a servo motor. In some embodiments, the motor 205 may be engaged with the power transmission assembly 100 by a direct drive.

Referring now to FIG. 2B, a side view of an example power transmission assembly 100 is shown coupled to a motor 205 according to some embodiments of the present disclosure. In some embodiments, the motor 205 may be coupled to the harmonic drive shaft 120 of the power transmission assembly 100. In some embodiments, the motor 205 controls the rotation of the harmonic drive shaft 120, such that the rotation of the harmonic drive shaft 120 may be adjusted to adjust the phase and torque of the power transmission assembly 100. This adjustment may be achieved while the power transmission assembly 100 is in motion.

FIG. 3 illustrates an example harmonic drive that may be used in the power transmission assembly 100 of FIG. 1. The harmonic drive explained may be an off-the-shelf part. A person of skill in the art will understand the operation of the present harmonic drive. A person of skill in the art will understand that the gear ratio between the flexspline 125 and the circular spline 127 will affect the relationship between the first torque 460 and the second torque 470, as shown in FIG. 4. In some embodiments, the gear ratio is 160:1.

FIG. 4 illustrates an example power transmission assembly 100 showing torque directions according to some embodiments of the present disclosure. In some embodiments, as the harmonic drive shaft 120 is rotated counter-clockwise, for example, with a first torque 460, the first input gear 115 of the first shaft 110 may rotate clockwise with a second torque 470. In some embodiments, as the first input gear 115 of the first shaft 110 rotates clockwise with the second torque 470, the second input gear 155 of the second shaft 150 may rotate counter-clockwise with a third torque 480. In some embodiments, with the operation of the illustrative power transmission assembly 100 as discussed in relation to FIG. 1, the second torque 470 and the third torque 480 may have a greater magnitude than the first torque 460. In some embodiments, the second torque 470 and the third torque 480 are substantially equal in magnitude.

In some embodiments, the illustrative power transmission assembly 100 is configured to enable infinitely variable shaft phasing for high speed and high torque applications. In some embodiments, the harmonic drive shaft 120 is rotated at 10,000 RPM with a first torque 460 of 3.2 Nm to produce a second torque 470 with a magnitude of 500 Nm. The rotation of the harmonic drive shaft 120 may be adjusted to produce a second torque 470 with a different magnitude. In some embodiments, the harmonic drive shaft 120 may be rotated at up to 15,000 RPM. In some embodiments, the second torque 470 may have a magnitude of up to 4000 Nm. Existing phase adjusters fall short of these values due to different designs and arrangements. In fact, the existing phase adjusters cannot operate for applications that require higher ranges of speed and torque, as are listed here.

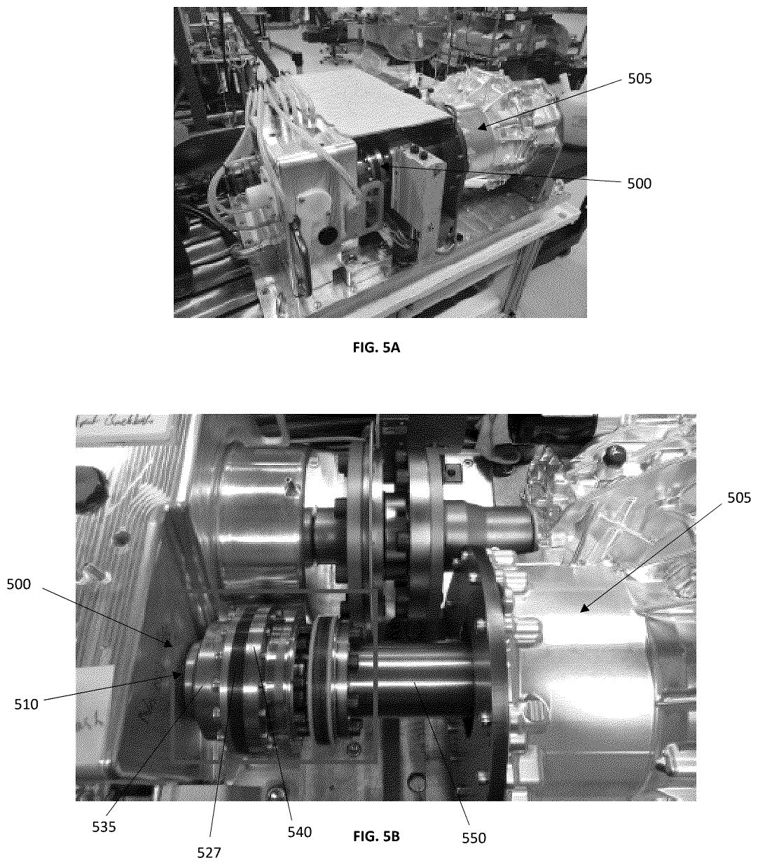

FIG. 5A illustrates an example application of a power transmission assembly 500 according to some embodiments of the present disclosure. In one or more embodiments. The assembly 500 may be the assembly 100 shown in FIG. 1. The power transmission assembly 500 may be used in any application where a compact and efficient rotary torque adjustment is necessary. In some embodiments, the power transmission assembly 500 may be used in in rotary test applications, which have a requirement to adjust torque in the system while it is actively rotating. In some embodiments, a power transmission assembly 500 may augment a gear tester used for gear development and validation. In some embodiments, the power transmission assembly 500 may augment a 4Square device 505. The 4Square device 505 is the ubiquitous industry standard test for gear and bearing component level testing. The 4Square device 505 enables accelerated gear bending damage characterization. As compared to other dyno tests, the 4Square device 505 augmented with the power transmission assembly 500 can yield results approximately 16 times faster. The 4Square device 505 augmented with the power transmission assembly 500 is enabled to perform full torque reversal due to the infinite variability of the torque and the dynamic phase adjustment of the power transmission assembly 500 while the power transmission assembly 500 is in motion.

FIG. 5B illustrates a power transmission assembly 500 in an example application according to some embodiments of the present disclosure. In one or more embodiments, the assembly 500 may be the assembly 100 shown in FIG. 1. In some embodiments, the harmonic drive, including the circular spline 527, enable autonomous dynamic torque load profiles and autonomous efficiency sweeps. Due to the nature of the harmonic drive enabling infinite rotation, the power transmission assembly 500 may be in operation longer than previous torque adjusters as there is no need to stop the power transmission assembly 500 to manually adjust the torque. The application of the power transmission assembly 500 in the square device 505 creates a mechanical torque loop which enables high gear stresses to be imposed efficiently. As the second shaft 550 twists relative to the first shaft 510, stresses are induced on a gear being tested effectively loading the gear to full drive unit torque.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

The following terms shall have, for the purposes of this application, the respective meanings set forth below. Unless otherwise defined, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a,” “an,” “the,” “said,” etc. also signify “at least one” or “the at least one” in the specification, claims and drawings, unless the context clearly dictates otherwise.

As used herein, the term “about” means plus or minus 10% of the numerical value of the number with which it is being used. Therefore, about 50 mm means in the range of 45 mm to 55 mm.

As used herein, the term “consists of” or “consisting of” means that the device or method includes only the elements, steps, or ingredients specifically recited in the particular claimed embodiment or claim.

As used here, the term “infinite rotation” means that the device may be rotated in a single direction without the device failing and without having to stop the rotation to reset the device to 0 degrees.

In embodiments or claims where the term “comprising” is used as the transition phrase, such embodiments can also be envisioned with replacement of the term “comprising” with the terms “consisting of” or “consisting essentially of.”

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A power transmission assembly comprising:
a first shaft along an axis, the first shaft having a first end and a second end;
a second shaft along the same axis as the first shaft, the second shaft having a first end and a second end, the first end of the second shaft being configured to engage with the second end of the first shaft;
a first input gear coupled to a portion of the first shaft;
a harmonic drive shaft engaged coaxially within the first shaft;
a harmonic drive engaged with the harmonic drive shaft adjacent the second end of the first shaft, the harmonic drive further engaged with the first end of the second shaft; and
a second input gear coupled to a portion of the second shaft.

2. The power transmission assembly of claim 1, wherein the harmonic drive comprises:
an elliptical wave generator coupled to the harmonic drive shaft;
a flexspline engaged with the elliptical wave generator; and
a circular spline surrounding at least a portion of the flexspline, the circular spline engaged with the flexspline, the circular spline configured to engage with the first end of the second shaft.

3. The power transmission assembly of claim 2, further comprising:
a flexspline adapter coupled to the flexspline, the flexspline adapter configured to engage with the second end of the first shaft, such that the flexspline and the first shaft are configured to rotate together.

4. The power transmission assembly of claim 2, wherein the circular spline and the second shaft are configured to rotate together.

5. The power transmission assembly of claim 4, further comprising:
a circular spline adapter coupled to the circular spline, the circular spline adapter configured to engage with the second shaft.

6. The power transmission assembly of claim 2, further comprising:
a shaft support coupled to the circular spline, the shaft support configured to align the first shaft and second shaft along the same axis.

7. The power transmission assembly of claim 1, further comprising:
a motor assembly coupled to the harmonic drive shaft, the motor assembly configured to control the rotation of the harmonic drive shaft.

8. The power transmission assembly of claim 1, wherein the harmonic drive shaft is configured to control the phase adjustment of the power transmission assembly.

9. The power transmission assembly of claim 8, wherein the harmonic drive shaft is configured to provide dynamic phase adjustment of the power transmission assembly while the power transmission assembly is in motion.

10. The power transmission assembly of claim 1, wherein the harmonic drive is configured to provide a 160:1 gear ratio.

11. A method of gear testing comprising:
providing a power transmission assembly, the power transmission assembly comprising:
a first shaft along an axis, the first shaft having a first end and a second end;
a second shaft along the same axis as the first shaft, the second shaft having a first end and a second end, the first end of the second shaft configured to engage with the second end of the first shaft;
a first input gear coupled to a portion of the first shaft;
a harmonic drive shaft engaged coaxially within the first shaft;
a harmonic drive engaged with the harmonic drive shaft adjacent the second end of the first shaft, the harmonic drive further engaged with the first end of the second shaft; and
a second input gear coupled to a portion of the second shaft;
applying a first torque to the harmonic drive shaft, the first torque causing a second torque exerted on the first shaft, such that the second torque direction is opposite the first torque direction; and
wherein the second torque causes the first input gear to rotate in the same direction as the first shaft.

12. The method of claim 11, wherein the second torque causes a third torque applied to the second shaft, the third torque applied in a direction opposite the second torque, the third torque causing the second input gear to rotate in the same direction as the second shaft.

13. The method of claim 12, wherein the second torque and the third torque are greater than the first torque.

14. The method of claim 11, wherein the first torque is supplied by a motor engaged with the harmonic drive shaft.

15. The method of claim 11, wherein the harmonic drive shaft is configured to provide dynamic phase adjustment of the power transmission assembly while the power transmission assembly is in motion.
